(19) United States
(12) Patent Application Publication
(10) Pub. No.: US 2023/0031950 A1
(43) Pub. Date: Feb. 2, 2023

(54) A GLIDE BOMB AND METHODS OF USE THEREOF

(71) Applicant: Skyborne Technologies Pty. Ltd., Queensland (AU)

(72) Inventor: Michael Creagh, Queensland (AU)

(21) Appl. No.: 17/911,663

(22) PCT Filed: Apr. 6, 2021
(86) PCT No.: PCT/AU2021/050312

§ 371 Date: Sep. 15, 2022

(30) Foreign Application Priority Data
Apr. 6, 2020 (AU) 2020901073

(51) Int. Cl. F42B 15/10; F42B 10/64; F41G 7/22; F41G 7/34

(52) U.S. Cl. CPC F42B 15/105; F42B 10/64; F41G 7/226; F41G 7/346

(57) ABSTRACT

The present invention relates to a glide bomb and methods of use thereof for use with an unmanned or manned aerial vehicle or for operative deployment. In one form, the glide bomb is configured to be carried and released by an unmanned aerial vehicle (“UAV”) for flight towards a selected target. The glide bomb includes an elongate body having a nose and an opposed tail aligned along a longitudinal axis; a payload; a pair of wings extendable from opposed sides of the body for producing lift, said wings configured to be selectively moveable between a retracted position and an extended position; and two or more tail control surfaces operatively associated with the tail of the body for at least pitch and yaw control.

### TECHNICAL FIELD

The present invention relates to a glide bomb and method of use thereof. In some forms, the glide bomb is configured to be deployed from an unmanned or manned aerial vehicle. In other forms, the glide bomb is configured to be operative deployed from the top of a building, mountain or cliff face, for example.

### BACKGROUND

UAVs capable of carrying projectiles have become an increasingly popular alternative to conventional loitering munitions as they are relatively inexpensive to operate can provide battle damage assessment and are capable of being reloaded.

However, a deficiency with current UAVs is the limited strike range offered by the carried types of unguided projectiles. For example, during a typical operation, a UAV may be up to 2,500 m away from its operator carrying 40 mm low velocity grenades with an accurate strike range of between about 50 m and about 120 m. This type of proximity to target, as well as bi-directional radio-frequency (“RF”) communications, dependency on global navigation satellite systems (“GNSS”) and radar signature, exposes the UAV and its operator to detection, RF jamming/spoofing and other counter-UAV techniques, such as, e.g., hard kills with small arms.

It will be clearly understood that, if a prior art publication is referred to herein, this reference does not constitute an admission that the publication forms part of the common general knowledge in the art in Australia or in any other country.

### SUMMARY OF INVENTION

Embodiments of the present invention provide a glide bomb and methods of use thereof, which may at least partially address one or more of the problems or deficiencies mentioned above or which may provide the public with a useful or commercial choice.

According to a first aspect of the present invention, there is provided a glide bomb configured to be carried and released by an unmanned or manned aerial vehicle for flight towards a selected target, said glide bomb including:

an elongate body having a nose and an opposed tail aligned along a longitudinal axis;

a payload;

a pair of wings extendable from opposed sides of the body for producing lift, said wings configured to be selectively moveable between a retracted position and an extended position; and

two or more tail control surfaces operatively associated with the tail of the body for at least pitch and yaw control.

According to a second aspect of the present invention, there is provided an unmanned or manned aerial vehicle including:

at least one glide bomb according to the first aspect.

Advantageously, the glide bomb of the present invention provides a new weapons category for unmanned aerial vehicles (“UAVs”) that extends a UAV's strike range from about 120 m from UAV to target to between about 1,500 m and about 4,500 m depending upon the terrain and altitude of the UAV. In turn, the glide bomb removes the UAV and its operator away from detection and harm by enabling the glide bomb to be deployed at a distance. Furthermore, the glide bomb once deployed is fully autonomous thereby removing any RF or acoustic signature vulnerabilities. Lastly, upon deployment the UAV may advantageously undertake a damage assessment.

The glide bomb of the present invention will be primarily described in relation to use with UAVs. A person skilled in the art, however, will appreciate that the glide bomb may have broader uses, such as, e.g., with a manned aerial vehicle or operative deployed.

As used herein, the term “Unmanned Aerial Vehicle” or “UAV” may include any unmanned aerial vehicle without a human pilot aboard. The UAV may be operated with varying degrees of autonomy ranging from fully autonomous to intermittently autonomous or may be remotely controlled by a human operator.

The UAV may preferably be a rotary-wing aircraft, although it is also envisaged that the UAV may have air foils. The UAV may be capable of freely moving within the environment with respect to six degrees of freedom (e.g., three degrees of freedom in translation and three degrees of freedom in rotation). Further, the UAV may be capable of taking off from a surface, landing on a surface, maintaining its current position and/or orientation (e.g., hovering), and/or changing its position.

In preferred embodiments, the UAV may be as disclosed in WO 2021/046592 A1, which is herein incorporated by reference in its entirety.

As used herein, the term “longitudinal axis” may refer to an axis that extends through the body and the centre of gravity of the glide bomb between the nose and the tail.

As used herein, the term “roll axis” may refer to an axis having its origin at the centre of gravity of the glide bomb and extending forward along the longitudinal axis. Motion about the roll axis is called “roll”. A positive roll motion may raise the left wing and lower the right wing. Conversely, a negative roll may lower the left wing and raise the right wing. A “roll angle” may refer to an angle of motion relative to the roll axis.

As used herein, the term “pitch axis” may refer to an axis having its origin at the centre of gravity of the glide bomb and extending planar to the roll axis in an orientation perpendicular to the roll axis. Motion about the pitch axis is called “pitch”. A positive pitch motion raises the nose of the glide bomb and lowers the tail. Conversely, a negative pitch lowers the nose of the glide bomb and raises the tail. A “pitch angle” may refer to an angle of motion relative to the pitch axis.

A used herein, the term “yaw axis” may refer to an axis that has its origin at the centre of gravity of the body of the glide bomb and extends downwards into an orientation perpendicular to the pitch axis. Motion about the yaw axis is call “yaw”. A positive yaw motion moves the nose of the glide bomb to the right. Conversely, a negative yaw motion moves the nose to the left. A “yaw angle” may refer to an angle of motion relative to the yaw axis.

The glide bomb of the present invention may advantageously provide an extended strike range for a UAV. For example, the glide bomb may have a flight range from deployment from the UAV to the target of about 1,500 m, about 1,600 m, about 1,700 m, about 1,800 m, about 1,900 m, about 2,000 m, about 2,100 m, about 2,200 m, about 2,300 m, about 2,400 m, about 2,500 m, about 2,600 m, about 2,700 m, about 2,800 m, about 2,900 m, about 3,000 m, about 3,100 m, about 3,200 m, about 3,300 m, about 3,400 m, about 3,500 m, about 3,600 m, about 3,700 m, about 3,800 m, about 3,900 m, about 4,000 m, about 4,100 m, about 4,200 m, about 4,300 m, about 4,400 m, or about 4,500 m. Typically, the glide bomb may have strike range from deployment to target of between about 2,000 m and about 4,000 m.

As indicated, the glide bomb includes an elongate body from which the pair of wings extend. The elongate body may be of any suitable size, shape and construction and may be formed from any suitable material or materials.

Generally, the elongate body may be formed from a lightweight material or materials with high stiffness, strength and fatigue performance. Typically, the elongate body may be formed from metal and/or plastic material or materials, or composites thereof. In some embodiments, the elongate body may be formed from aluminium or a carbon fire composite.

As indicated, the body includes a nose at a forward or front end of the body and an opposed tail at a rear end of the body. The nose and tail are aligned along the longitudinal axis.

The body may include an aerodynamic outer shell. The shell may be of integral construction or may be formed from two or more shell parts connected together. The shell may preferably be formed from lightweight material or materials with high stiffness, strength, and fatigue performance. For example, the shell may be formed from metal and/or plastic material or materials, or composites thereof. In some embodiments, the shell may be formed from aluminium or a carbon fire composite.

The shell may have any suitable cross-sectional shape along the longitudinal axis. For example, in some embodiments, the shell may have a circular or oval-shaped cross-section. In other embodiments, the shell may have a substantially triangular, rectangular or other polygonal cross-section.

In yet other embodiments, the shell may have a substantially rectangular cross-sectional shape at its widest point with an upper wall, an opposed lower wall and opposed sidewalls extending longitudinally between the nose and the tail.

As indicated, the shell may have a substantially aerodynamic shape. For example, the shell may include rounded edges and/or corners between a sidewall and an upper wall and/or lower wall and between a nose or tail and an adjacent sidewall, upper wall, or lower wall. Generally, the walls and sidewalls may at least partially taper at or near each of the nose and the tail.

In some embodiments, the shell may be of a size and shape and formed of a material or materials to reduce reflection/emission of one or more of radar, infrared, visible light, radiofrequency (“RF”) spectrum and audio. For example, the shell may be formed from radar-absorbent material or materials, such as, e.g., material or materials containing carbon black particles or tiny iron spheres.

The shell may preferably be configured to house internal components of the glide bomb, such as, e.g., the payload and internal electronic components. The shell may include one or more openings defined therein for the protrusion of components, such as, e.g., sensors, antennas, and the like.

As indicated, the glide bomb includes a pair of wings extendable from opposed sides of the body. The wings may be of any suitable size, shape and construction and formed from any suitable material or materials.

Generally, each wing may be a substantially flat structure that extends longitudinally from a side of the body when in an extended position. In some embodiments, the wing may be of solid construction. In other embodiments, the wing may be of tubular construction. Preferably, the wings may be air foils.

Each wing may have opposed surfaces extending substantially parallel to one another and interconnected by opposing ends and edges.

For example, in some embodiments, each wing may include an upper surface and an opposed lower surface. The opposed surfaces may be interconnected by opposing ends and edges, including an outer end, an opposed inner end operatively connected to a side of the body of the glide bomb, a leading longitudinal side edge and an opposed trailing longitudinal side edge.

Typically, the wings may be of a size and shape to produce lift. In this regard, each wing may usually include a rounded leading side edge and a sharp opposed trailing side edge. Each wing may taper in width as it extends longitudinally from the inner end to the outer end.

The wings may span any suitable distance from tip to tip when in the extended position. For example, the wings may have a span of about 350 mm, about 360 mm, about 370 mm, about 380 mm, about 390 mm, about 400 mm, about 410 mm, about 420 mm, about 430 mm, about 440 mm, about 450 mm, about 460 mm, about 470 mm, about 480 mm, about 490 mm, about 500 mm, about 510 mm, about 520 mm, about 530 mm, about 540 mm, about 550 mm, about 560 mm, about 570 mm, about 580 mm, about 590 mm, about 600 mm, about 610 mm, about 620 mm, about 630 mm, about 640 mm, about 650 mm, about 660 mm, about 670 mm, about 680 mm, about 690 mm, about 700 mm, about 710 mm, about 720 mm, about 730 mm, about 740 mm, about 780 mm, about 790 mm, or even about 800 mm. Typically, the glide bomb may have a wingspan of between about 500 mm and about 700 mm, preferably about 650 mm.

Generally, each wing may be formed from lightweight material or materials with high stiffness, strength, and fatigue performance. Typically, each wing may be formed from metal and/or plastic material or materials, or composites thereof. Preferably, each wing may be formed from aluminium or a carbon fire composite.

In some embodiments, like the shell, the wings may be formed from radar-absorbent material or materials.

Each wing may be pivotally mountable to the body in any suitable way that allows the wing to pivot about the inner end and the outer end to be pivotable between the retracted and extended positions. For example, the inner end of each wing may be directly or indirectly mountable to the body.

In some embodiments, each wing may be connectable to the body by a connecting mechanism or part of a connecting mechanism. The connecting mechanism may include a first part associated with the inner end of the wing and a second part connectable to the first part and associated with the body of the glide bomb.

The parts of the connecting mechanism may respectively include mateable male and female portions that couple together, including threaded connections, interference fit connections or bayonet-type connections, for example.

For example, a first part of the connecting mechanism associated with the inner end of the wing may include a male formation configured to be inserted into or coupled with a female formation of a second part of the connecting mechanism associated with the body. Conversely, the first part of the connecting mechanism associated with the inner end of the wing may include a female formation configured to receive or be coupled with a male formation of the second part of the connecting mechanism associated with the body.

In other embodiments, the inner end of each wing may be pivotally coupled to the body by way of a coupling mount.

The coupling mount may be of any suitable size, shape and construction and configured to at least partially couple with the inner end of the wing and facilitate at least a partial pivot of the wing about its inner end.

For example, in some embodiments, the coupling mount may include a plurality of bearings to facilitate at least a partial pivot of the wing relative to the body.

A pivot pin may pivotally pin the inner end of each wing to its respective coupling mount.

In yet other embodiments, each wing may hingedly connected or coupled to the body to enable the outer end of each wing to be pivotable between the extended and retracted positions.

Each wing may be selectively pivotable relative to the body over any suitable range between the retracted and extended positions. For example, each wing may be selectively pivotable over a range of about 70°, about 75°, about 80°, about 85°, about 90° or even about 95°. Preferably, over a range of about 90°.

Generally, each wing may be selectively rotatable between the retracted and extended positions.

When the wings are in the extended position, they may provide lift to the glide bomb. Conversely, when the wings are in the retracted position, lift and/or drag may be reduced if not minimised. Further, when the wings are in the retracted position, any interference with the UAV may also be at least partially reduced.

Additionally, the wings may be able to be moved to one or more positions between the retracted and extended positions.

For example, in some embodiments, the wings may be able to be moved to a swept back position for high-speed flight, for roll control, and/or for longitudinal trim of the glide bomb in flight. For example, a left wing may be selectively moved to the swept back position for a negative roll motion of the glide bomb. Conversely, a right wing may be selectively moved to the swept back position for a positive roll motion of the glide bomb.

In other embodiments, the wings may be selectively moved to two or more swept back positions. For example, each wing may be selectively moveable between a minimum sweep position and a maximum sweep position.

In preferred embodiments, the wings may each be selectively moveable to variable sweep angles required to achieve a desired performance.

Pivoting of each wing relative to the body of the glide bomb may be actuated by any suitable mechanism, such as, e.g., an engine or motor. Typically, pivoting of each wing relative to the body of the glide bomb may be driven by a servomotor or stepper motor.

In use, selective pivoting of the wings may enable the glide bomb to transition between a stowage and freefall mode, a low-speed flight mode, a high-speed flight mode and for roll control as required.

Preferably, when in the retracted position, the outer end of each wing may be pivoted towards the tail of the body of the glide bomb.

As indicated, the glide bomb includes two or more tail control surfaces operatively associated with the tail of the body for at least pitch and yaw control. The tail control surfaces may be of any suitable size, shape and construction and formed from any suitable material or materials.

Like the body and the wings, the tail control surfaces may be formed from lightweight material or materials with high stiffness, strength, and fatigue performance. Typically, each tail control surface may be formed from metal and/or plastic material or materials, or composites thereof. Preferably, each tail control surface may be formed from aluminium or a carbon fire composite.

In some embodiments, the tail control surfaces may include at least one vertical stabiliser (also known as a “fin”) and at least one horizontal stabiliser.

The vertical stabiliser may be a vertical wing-like surface mounted at the tail of the body. The vertical stabiliser may protrude upwardly or downwardly relative to the tail, preferably downwardly.

The vertical stabiliser may stabilise the glide bomb's yaw. Preferably, the vertical stabiliser may include at least one rudder. The rudder may be pivotable about a vertical axis relative to the vertical stabiliser to control the yaw motion of the glide bomb.

The horizontal stabiliser is a horizontal wing-like surface mounted at the tail of the body or on the vertical stabiliser. The horizontal stabiliser may stabilise the glide bomb's pitch. Preferably, the horizontal stabiliser may include at least one elevator. The elevator may be pivotable about a horizontal axis relative to the horizontal stabiliser to control the pitch motion of the glide bomb.

In preferred embodiments, the tail control surfaces may include a pair of horizontal stabilisers mounted to and extending from opposed sides of the tail. Each of the stabilisers may include an inner end mountable to the tail, an opposed outer end and an elongate body extending therebetween.

Like with the wings, in some embodiments, the pair of opposed horizontal stabilisers may be moveable between a retracted position in which the stabilisers are folded, or pivoted, against the elongate body of the glide bomb and an extended position in which the horizontal stabilisers are operable.

The pair of opposed horizontal stabilisers may be pivotally mountable to the elongate body of the glide bomb in any suitable way that allows each stabiliser to pivot about its inner end and the outer end to be pivotable between the retracted and extended positions. Each horizontal stabiliser may be directly or indirectly mountable to the body.

Preferably, when in the retracted position, the outer end of each stabiliser may be pivoted towards the nose of the body of the glide bomb.

Advantageously, when the pair of horizontal stabilisers are in the retracted position, any interference with the UAV carrying the glide bomb is at least partially reduced.

In use, the glide bomb may be configured to pivot the horizontal stabilisers to the extended position as soon as the glide bomb is released from the UAV or operative to thereby provide at least partial flight control.

Like with the wings, each horizontal stabiliser in such embodiments may be connectable to the body by a connecting mechanism or part of a connecting mechanism, a coupling mount and pivot pin arrangement or hinged connection as previously described.

Each horizontal stabiliser may be selectively pivotable relative to the body over any suitable range between the retracted and extended positions. For example, each horizontal stabiliser may be selectively pivotable over a range of about 70°, about 75°, about 80°, about 85°, about 90° or even about 95°. Preferably, over a range of about 90°.

Generally, each horizontal stabiliser may be selectively pivotable between the retracted and extended positions.

Additionally, the horizontal stabilisers may be pivotable to one or more positions between the retracted and extended positions.

Like with the wings, pivoting of the horizontal stabilisers relative to the body of the glide bomb may be actuated by any suitable mechanism, such as, e.g., an engine or motor. Typically, the pivoting of each horizontal stabiliser relative to the body may be driven by a servomotor or stepper motor.

In other embodiments, the tail control surfaces may be arranged in a V-shaped configuration protruding either upwardly or downwardly from the tail of the body, preferably upwardly. The tail control surfaces may stabilise the glide bomb's yaw and pitch.

In such embodiments, each control surface may include at least one ruddervator along a portion of a rear or aft edge of the control surface. The ruddervator may be pivotable about and relative to a longitudinal axis of the control surface.

Each of the at least one ruddervator along each of the control surfaces may be selectively pivotable to control the yaw motion and pitch motion of the glide bomb.

In yet other embodiments, the tail control surfaces may be arranged in an X-shaped configuration. In such embodiments, the tail control surface may be arranged in a similar arrangement as in the V-shaped configuration save that the control surfaces protrude both upwardly and downwardly from the tail of the body.

In such embodiments, each tail control surface may include two or more ruddervators.

Like with the wings, pivoting of the rudder, elevator or ruddervator relative to the control surface of the glide bomb may be actuated by any suitable mechanism, such e.g., an engine or motor. Typically, pivoting of the rudder, elevator or ruddervator relative to the tail control of the glide bomb may be driven by a servomotor or stepper motor.

As indicated, the glide bomb includes a payload. The payload may be of any suitable form and weight.

For example, in some embodiments, the payload may be a warhead, such as, e.g., an explosive warhead, a nuclear warhead, a chemical warhead or a biological warhead. Conversely, in other embodiments, the payload may not be a warhead. For example, in such embodiments, the payload may include a communications node, an IR beacon, a shaped charge, an electronic-warfare (“EW”) jammer or a communications repeater.

Generally, the payload may be of any suitable weight to be carried by the glide bomb and the UAV. For example, the payload may have a weight of about 100 g, about 150 g, about 200 g, about 250 g, about 300 g, about 350 g, about 400 g, about 450 g, about 500 g, about 550 g, about 600 g, about 650 g, about 700 g, about 750 g, about 800 g, about 850 g, about 900 g, about 950 g, about 1,000 g, about 1,050 g, about 1,100 g, about 1,150 g, about 1,200 g, about 1,250 g, about 1,300 g, about 1,350 g, about 1,400 g, about 1,450 g or even 1,500 g or more. Typically, the glide bomb may carry a payload ranging in weight between about 100 g and about 1,000 g, preferably between about 400 g and about 800 g, more preferably about 600 g.

Typically, the payload may be an explosive warhead. Examples of such warheads include flash, smoke, high explosive, high explosive dual purpose, and non-lethal explosive warheads, such as, e.g., 2-chlorobenzalmalononitrile or CS gas (i.e., tear gas).

Generally, the warhead may include a detonator/fusing device. The detonator/fusing device may include a contact detonator, a proximity detonator, a remote detonator, a timed detonator, an altitude detonator, or any combination thereof. Preferably, the detonator/fusing device or combination of detonators/fusing devices may enable both ground burst and airburst at differing altitudes.

In some embodiments, the warhead may be a HE-Frag warhead with a total mass of about 600 g, including 200 g of explosive.

The glide bomb may be mounted to a UAV in any suitable way to be releasable when deployed. Typically, the glide bomb may be mounted to the UAV by a release mechanism. The release mechanism may be operatively associated with a firing mechanism of the UAV for triggering deployment of the glide bomb from the UAV upon receiving a firing command.

The release mechanism may be of any suitable size, shape, and form. Generally, the release mechanism may include a glide bomb holder attached to an underside of a UAV. The glide bomb holder may include one or more locks configured to lock the glide bomb to the holder. The locks may be configured to transition from a locked state to an unlocked state and release the bomb via the release mechanism, preferably in a synchronous manner. Typically, the glide bomb may include one or more corresponding mounting slots configured to at least partially receive one or more mounting forks of the one or more locks when in the locked state. The one or more mounting slots may be defined on an upper surface of the body of the glide bomb.

The firing mechanism may be operatively associated with a firing pin or drive configured to manually actuate and release the locks of the release mechanism. The firing pin or drive may be a linear drive, although non-linear movement such as rotary movement is also envisaged.

In preferred embodiments, the firing mechanism may include an electromechanical solenoid. Typically, the electromechanical solenoid may slide the firing pin or drive to synchronously release the locks of the release mechanism.

In some embodiments, the glide bomb may include at least one image capturing device to facilitate flight control. The at least one image capturing device may include any suitable device capable of capturing a plurality of images and/or video, depending on the type of image capturing device.

For example, in some embodiments, the image capturing device may include any one of a camera, a digital camera, a video camera, a thermographic camera, a night vision camera or any combination thereof.

The at least one image capturing device may preferably be located at or near the nose of the body of the glide bomb.

In some embodiments, the glide bomb may further include a range finder for determining a distance between the glide bomb and a target. The range finder may preferably be a laser range finder.

In some embodiments, the glide bomb may include at least one sensor, such as, e.g., a pressure sensor, a guidance sensor, or a RF sensor. For example, in some such embodiments, the at least one sensor may include an infrared and/or laser sensor for detecting laser illuminated targets. In other such embodiments, the glide bomb may include a RF sensor for detecting RF jammers and/or RF disruptors, and optionally enabling the glide bomb to target their respective positions. In yet other such embodiments, the glide bomb may include at least one pitot probe for measuring fluid flow velocity and therefore airspeed.

The glide bomb may preferably include at least one guidance system for guiding flight of the glide bomb to the target when released from the UAV and after having received the target coordinates from the UAV prior to release, preferably via a wire or wireless connection. The at least one guidance system may include an inertial navigation system, a global navigational satellite system (“GNSS”), or a combination thereof, preferably the latter.

The glide bomb may be guided with varying degrees of autonomy ranging from fully autonomous to intermittently autonomous or may be remotely controlled by a human operator.

The GNSS of the glide bomb may include at least one GNSS antenna and optionally at least one modem. The GNSS antenna may be configured to receive radio waves from artificial satellites for determining positional coordinates of the glide bomb, preferably GNSS satellites, more preferably at least four GNSS satellites. The GNSS antenna may preferably be a Global Positioning System (“GPS”) antenna.

Typically, the glide bomb may further include a GNSS receiver associated with the at least one GNSS antenna for receiving output from the antenna, preferably a GPS receiver.

The at least one modem may be configured to be in communication with an external controller, such as, e.g., a remote controller and/or a remotely accessible server, for the transmission of data between the external controller and the at least one modem. The at least one modem may be a cellular or radio modem.

The inertial navigation system of the glide bomb may include an inertial measurement unit (“IMU”) for determination of the glide bomb's position relative to the target when GNSS-signals are unavailable, disrupted or jammed.

In some embodiments, the at least one guidance system may be configured to switch from the GNSS to the inertial navigation system as the glide bomb nears the target. Advantageously, this may at least partially reduce any interference to guidance of the glide bomb caused by a loss of GNSS-signals, such as, e.g., when they are unavailable, disrupted or jammed. Further, any positional drift is advantageously minimal due to the short flight time of the glide bomb when solely under the inertial navigation system. For example, it is envisaged in use that the inertial navigation system may only have to operate for six seconds without GNSS-corrections when the glide bomb is in a terminal strike mode. It is further envisaged that the glide bomb may have an estimate of circular error probable (“CEP”) of about 1.5 m.

The at least one guidance system of the glide bomb may further include at least one controller for controlling flight of the glide bomb to target the target. The controller may preferably be operatively associated with one or more of the GNSS, the inertial navigation system, the wings, the tail control surfaces, the at least one sensor, the at least one modem and any other electrical components of the glide bomb.

In preferred embodiments, the controller may be part of a microcomputer, including one or more processors and a memory. The processors may include multiple inputs and outputs coupled to the electronic components of the glide bomb.

The controller may preferably be in communication with an external controller over a communications network at least for part of a flight of the glide bomb. The external controller may be an external remote controller or the UAV from which the glide bomb is released. The network may include, among others, the Internet, LANs, WANs, a mesh network, a GPRS network, a mobile communications network, a radio network, etc., and may include wireless communications links.

In some embodiments, the controller of a first glide bomb may be in communication with the controller of other like glide bombs that have also been deployed to coordinate a strike, synchronous or near synchronous strike and/or collision avoidance, for example.

The glide bomb may preferably include a power supply for powering the electrical components of the glide bomb. The power source may include an on-board power source, such as, e.g., one or more batteries.

The at least one remotely accessible server may include any appropriate server computer, distributed server computer, cloud-based computer, server computer cluster or the like. The server may typically include one or more processors and one or more memory units containing executable instructions/software to be executed by the one or more processors.

The server may be in communication with the glide bomb and may be configured to transmit communications between the glide bomb and an external remote controller, for example.

The communications may include imaging data, positional data, and command data, including flight command data and abort command data.

In some embodiments, the glide bomb may further include a propulsion system to achieve a greater strike range. For example, the glide bomb may include a rocket motor, a propeller, or a gas turbine engine. In such embodiments, the glide bomb may further include a power supply or fuel source for the propulsion system.

In embodiments in which the glide bomb is operative deployed or deployed from a manned aerial vehicle, the glide bomb may receive the target coordinates from an external controller prior to being deployed, again preferably via a wired or wireless communications module, more preferably a wired serial link short range RF radio link (e.g., Bluetooth™). The external controller may be part of a weapons system of the manned aerial vehicle or may be a remote controller, such as, e.g., an external computing device.

In some embodiments, a part or portion of the glide bomb may be separable and detachable from a remainder of the glide bomb after deployment. The detachable part or portion of the glide bomb may include at least one of the at least one image capturing device, the range finder, the at least one sensor, the at least one guidance system and parts or portions thereof.

The part or portion of the glide bomb may be operatively associated with a salvage system including a parachute and/or a beacon so that the part or portion may be salvaged.

In use, the part of portion of the glide bomb may be configured to be detached from a remainder of the glide bomb as the glide bomb nears the target, typically when the at least one glide bomb is in the terminal strike mode.

According to a third aspect of the present invention, there is provided a method of deploying a glide bomb from an unmanned or manned aerial vehicle, said method including:

providing an aerial vehicle including at least one glide bomb according to the first aspect;

identifying a target and determining target information including a distance to target, a pitch angle, a yaw angle, and an altitude required to strike the target with the at least one glide bomb;

transmitting the target information to the at least one glide bomb; and

releasing the glide bomb.

According to a fourth aspect of the present invention, there is provided a method of operative deployment of a glide bomb, said method including:

providing at least one glide bomb according to the first aspect;

identifying a target and determining target information including a distance to target, a pitch angle, a yaw angle, and an altitude required to strike the target with the at least one glide bomb;

transmitting the target information to the at least one glide bomb; and

releasing the glide bomb.

The methods of the third and fourth aspects may include one or more features or characteristics of the glide bomb as hereinbefore described.

Generally, with the method of the fourth aspect, the operative may need to be based in a location with sufficient altitude for deployment of the glide bomb. For example, the operative may deploy the glide bomb from the top of a building, mountain, or cliff face.

The identifying a target and determining target information may be performed by a flight and targeting controller of the unmanned or manned aerial vehicle or using an external remote controller of the operative. The flight and targeting information may also determine any obstacles between the aerial vehicle and the target, such as, e.g., buildings, trees, mountains, hills, and the like.

The target information may include target coordinates.

The target information may be transmitted either via a wireless or wired link, preferably the latter, more preferably via a wired serial link between the aerial vehicle or operative and the glide bomb. The link may be configured to be severed when the glide bomb is released.

The releasing the glide bomb may be initiated upon receiving a firing command from the aerial vehicle operator or operative.

In some embodiments, the identifying may include coordinating a swarm attack on a target with multiple glide bombs carried by multiple aerial vehicles or operatives. In such embodiments, the identifying may further include determining the position of other aerial vehicles or operatives carrying glide bombs and coordinating the release of the glide bombs to minimise collisions and promote a synchronous or near synchronous strike of the target.

According to a fifth aspect of the present invention, there is provided a flight trajectory method for a glide bomb released from an unmanned or manned aerial vehicle or an operative, said method including:

transmitting target information to the at least one glide bomb of the first aspect, said target information including a distance to target, a pitch angle, a yaw angle and an altitude required to strike a target;

releasing the glide bomb from the aerial vehicle or operative and allowing the glide bomb to freefall to attain a desired velocity; and

upon reaching the desired velocity, moving the wings of the glide bomb from a retracted position towards an extended position and guiding the glide bomb to the target for target strike.

The method may include one or more features or characteristics of the glide bomb as hereinbefore described.

The transmitting may occur via a wireless or wired link, preferably the latter, more preferably via a wired serial link between the aerial vehicle or operative and the glide bomb. The link may be configured to be severed when the glide bomb is released.

As indicated, upon release, the glide bomb may freefall until a desired velocity is attained to maintain glided flight towards the target. The desired velocity may be determined via a determination of the dynamic pressure of the glide bomb.

Upon reaching the desired velocity, the wings of the glide bomb may transition from the retracted position to the extended position. The glide bomb may then achieve a velocity of about 90 km·h⁻¹, about 95 km·h⁻¹, about 100 km·h⁻¹, about 105 km·h⁻¹, about 110 km·h⁻¹, about 115 km·h⁻¹, about 120 km·h⁻¹, about 125 km·h⁻¹, about 130 km·h⁻¹, about 135 km·h⁻¹, about 140 km·h⁻¹, about 145 km·h⁻¹, or even about 150 km·h⁻¹.

The wings may transition from the retracted position towards the extended position to achieve an optimum glide ratio, preferably of about 10.

Further, the at least one guidance system of the glide bomb may then guide the glide bomb to the target for target strike.

In some embodiments, the method may further include transitioning to a terminal strike mode as the glide bomb nears the target. The transitioning may include monitoring the distance to target. Upon reaching a predetermined proximity to the target, the glide bomb may at least partially retract its wings and pitch downwards to accelerate the glide bomb for target strike. In such embodiments, it is envisaged that the glide bomb may attain a terminal velocity or near terminal velocity of about 260 km·h⁻¹, about 275 km·h⁻¹, about 280 km·h⁻¹, about 285 km·h⁻¹, about 290 km·h⁻¹, about 295 km·h⁻¹, about 300 km·h⁻¹, about 305 km·h⁻¹, about 310 km·h⁻¹, about 315 km·h⁻¹, about 320 km·h⁻¹, about 325 km·h⁻¹, about 330 km·h⁻¹, about 335 km·h⁻¹, about 340 km·h⁻¹, about 345 km·h⁻¹, about 350 km·h⁻¹, about 355 km·h⁻¹, about 360 km·h⁻¹, about 365 km·h⁻¹, about 370 km·h⁻¹, about 375 km·h⁻¹, about 380 km·h⁻¹, about 385 km·h⁻¹, about 390 km·h⁻¹, about 395 km·h⁻¹, about 400 km·h⁻¹, about 405 km·h⁻¹, about 410 km·h⁻¹, about 415 km·h⁻¹, about 420 km·h⁻¹, about 425 km·h⁻¹, about 430 km·h⁻¹, about 435 km·h⁻¹, about 440 km·h⁻¹, about 445 km·h⁻¹, or even about 450 km·h⁻¹ or more, preferably about 400 km·h⁻¹.

For example, it is envisaged that the glide bomb may provide a 2,000 m strike range when deployed or released at an altitude of about 250 m with a deployment to strike time of about 80 s.

Likewise, it is envisaged that the glide bomb may provide a 4,000 m strike range when deployed or released at an altitude of about 450 m with a deployment to strike time of about 135 s.

Any of the features described herein can be combined in any combination with any one or more of the other features described herein within the scope of the invention.

The reference to any prior art in this specification is not and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 is an upper perspective view of a glide bomb according to an embodiment of the present invention with the wings shown in a retracted position;

FIG. 2 is an upper perspective view of the glide bomb of FIG. 1 having been recently released by a UAV and with its wings in an extended position;

FIG. 3 is an upper perspective view of a glide bomb according to another embodiment of the present invention with the wings and horizontal stabilisers in a retracted position;

FIG. 4 is an upper perspective view of the glide bomb of FIG. 3 with its wings and horizontal stabilisers in an extended position;

FIG. 5 is a flowchart showing steps in a method of releasing the glide bomb as shown in FIGS. 1 to 4 from a UAV; and

FIG. 6 is a flowchart showing steps in a flight trajectory method of the glide bomb as shown in FIGS. 1 to 4 when approaching a target.

### DETAILED DESCRIPTION

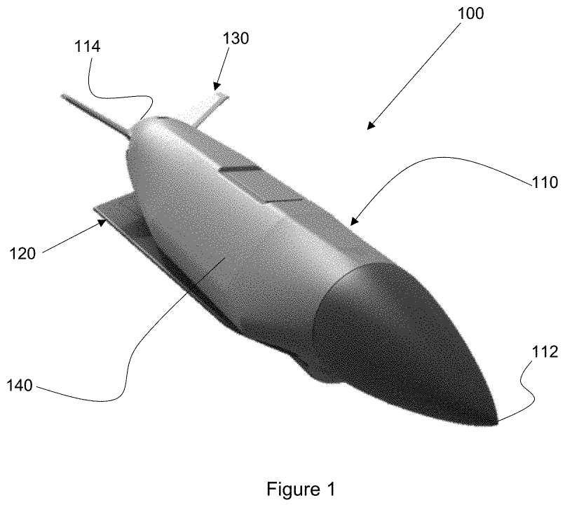

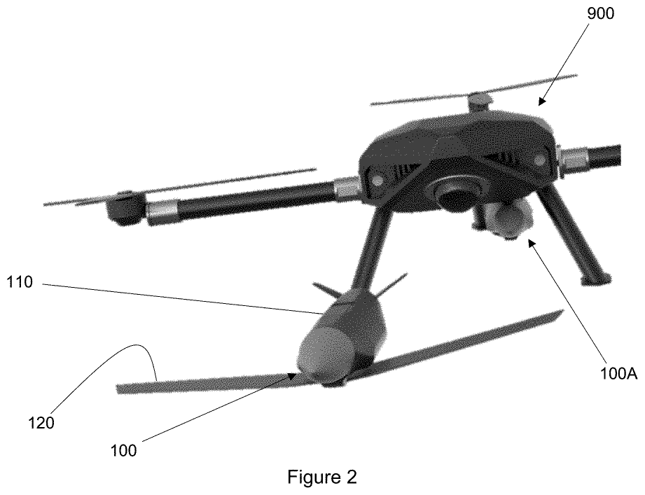

FIGS. 1 to 4 show embodiments of a glide bomb (100) configured to be carried and released by an unmanned aerial vehicle (“UAV”; 900; shown only in FIG. 2).

FIGS. 1 and 2 show a first embodiment of the glide bomb (100).

Referring to FIG. 1, the glide bomb (100) includes: an elongate body (110) having a nose (112) and an opposed tail (114) aligned along a longitudinal axis; a payload (not visible); a pair of wings (120) extendable from opposed sides of the body (110) for producing lift and configured to be selectively moveable between a retracted position (shown) and an extended position (see FIG. 2); and two or more tail control surfaces (130) operatively associated with the tail (114) of the body (110) for at least pitch and yaw control.

The elongate body (110) is formed from lightweight material or materials with high stiffness, strength and fatigue performance, such as, e.g., aluminium or a carbon fire composite.

The body (110) includes an aerodynamic outer shell (140). The shell (140) is also formed from lightweight material or materials with high stiffness, strength and fatigue performance, such as, e.g., aluminium or a carbon fire composite.

The shell (140) has a substantially circular cross-sectional shape that tapers at or near each of the nose (112) and tail (114) of the body.

The shell (140) is configured to house internal components of the glide bomb (100), such as, e.g., the payload and internal electronic components. The shell (140) includes one or more openings defined therein for the protrusion of components, such as, e.g., sensors, antennas and the like.

As indicated, the pair of wings (120) are extendable from opposed sides of the body (110). Each wing (120) is an air foil sized and shaped to produce lift. In this regard, each wing (120) includes a rounded leading side edge and a sharp opposed trailing side edge.

Referring briefly to FIG. 2, the wings (120) when in the extended position span about 650 mm from tip to tip.

The wings (120) are formed from lightweight material or materials with high stiffness, strength and fatigue performance, such as, e.g., aluminium or a carbon fire composite.

Each wing (120) is pivotally mountable to the body such that the wing (120) is able to be selectively pivoted between a retracted position (as shown in FIG. 1) and the extended position as shown.

Each wing (120) is selectively pivotable relative to the body over a range of about 90°.

When the wings (120) are in the extended position, they provide lift to the glide bomb (100). Conversely, when the wings (120) are in the retracted position, lift and/or drag are reduced. Further, when the wings (120) are in the retracted position, interference with the UAV (900) may is reduced enabling two glide bombs (100, 100A) to be mounted to an underside of the UAV (900).

In addition to moving between the retracted and extended positions, the wings (120) are selectively moveable to variable sweep angles therebetween to achieve desired flight characteristics.

For example, the wings (120) can be moved to a swept back position for high-seed flight, for roll control, and/or for longitudinal trim of the glide bomb (100) in flight. For example, a left wing (120) can be selectively moved to the swept back position for a negative roll motion of the glide bomb (100). Conversely, a right wing (120) can be selectively moved to the swept back position for a positive roll motion of the glide bomb (100).

Pivoting of each wing (120) relative to the body (110) of the glide bomb (100) is actuated by a servomotor.

In use, selective pivoting of the wings (120) enables the glide bomb (100) to transition between a stowage and freefall mode, a low-speed flight mode, a high-speed flight mode and for roll control as required.

Referring back to FIG. 1, the glide bomb (100) includes two tail control surfaces (130) arranged in a V-shaped configuration protruding upwardly from the tail (114) of the body (110). The tail control surfaces (130) stabilise the yaw and pitch of the glide bomb (100).

Each control surface (130) includes at least one ruddervator (not visible) along a portion of a rear or aft edge of the control surface (130). The ruddervator is pivotable about and relative to a longitudinal axis of the control surface (130) for controlling the yaw motion and pitch motion of the glide bomb (100). Like the wings (120), movement of the ruddervators is actuated by a servomotor.

While not shown, the payload of the glide bomb (100) includes a HE-Frag warhead with a total mass of about 600 g, including 200 g of explosive. However, other types of both explosive and non-explosive payloads are envisaged, such as, e.g., 2-chlorobenzalmalononitrile or CS gas (i.e., tear gas), nuclear warheads, chemical warheads, biological warheads, communications nodes, IR beacons, shaped charges, electronic-warfare (“EW”) jammer or communications repeaters.

The warhead includes a detonator/fusing device. The detonator/fusing device can include a contact detonator, a proximity detonator, a remote detonator, a timed detonator, an altitude detonator or any combination thereof enabling both ground burst and airburst at differing altitudes.

Referring again to FIG. 2, the glide bomb (100A) is mounted to an underside of the UAV (900) by a release mechanism operatively associated with a firing mechanism of the UAV (900) for triggering deployment of the glide bomb (100) from the UAV (900) upon receiving a firing command.

The release mechanism is a glide bomb holder (not visible) attached to an underside of the UAV (900) and includes one or more locks or electromagnets configured to releasably fasten the glide bomb (100A) to the holder. The electromagnets or locks are configured to release the bomb (100) in a synchronous manner upon receiving the firing command.

The glide bomb (100) includes a guidance system for guiding flight of the glide bomb (100) to the target when released from the UAV (900) and after having received target coordinates from the UAV (900) prior to release via a wired connection. The guidance system includes an inertial navigation system and a global navigational satellite system (“GNSS”).

Upon release, the guidance system of the glide bomb (100) autonomously guides the glide bomb (100) to the target for target strike.

In use, the guidance system is configured to switch from the GNSS to the inertial navigation system as the glide bomb (100) nears a target. Advantageously, this reduces any interference to guidance caused by a loss of GNSS-signals, such as, e.g., when unavailable, disrupted or jammed.

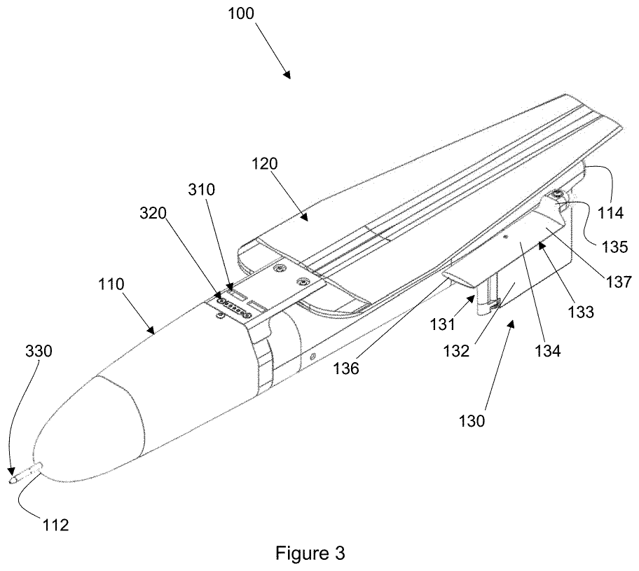

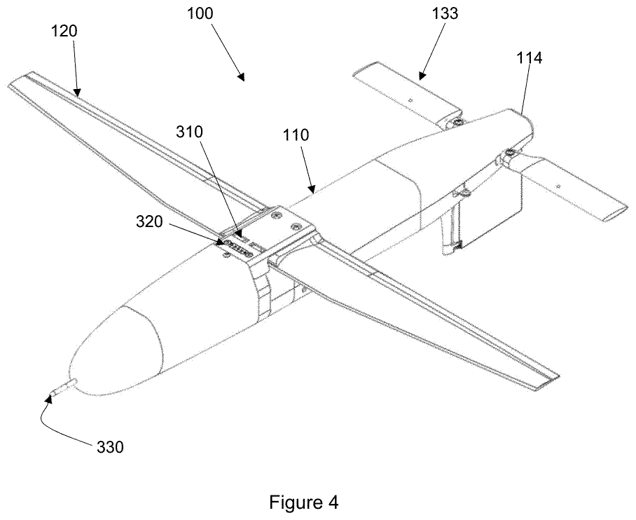

FIGS. 3 and 4 show a second embodiment of the glide bomb (100). For convenience, features that are similar or correspond to features of the first embodiment will be referenced with the same reference numerals.

Referring to FIG. 3, the glide bomb (100) includes: an elongate body (110) having a nose (112) and an opposed tail (114) aligned along a longitudinal axis; a payload (not visible); a pair of wings (120) extendable from opposed sides of the body (110) for producing lift and configured to be selectively moveable between a retracted position (shown) and an extended position (see FIG. 4); and two or more tail control surfaces (130) operatively associated with the tail (114) of the body (110) for at least pitch and yaw control.

In this embodiment, the two or more tail control surfaces (130) include: a downwardly extending vertical stabiliser (131) having a rudder (132) pivotable about a vertical axis relative to the vertical stabiliser (131) for controlling yaw motion of the glide bomb (100); and a pair of horizontal stabilisers (133) mounted to and extending from either side of the tail (114). Each horizontal stabiliser (133) has an elevator (134) pivotable about a horizontal axis relative to the horizontal stabiliser (133) for controlling pitch motion of the glide bomb (100).

Each horizontal stabiliser (133) includes an inner end (135) mountable to the tail (114), an opposed outer end (136) and an elongate body (137) extending therebetween.

Like with the wings (120), the horizontal stabilisers (133) are selectively moveable between a retracted position (shown) in which the stabilisers (133) are folded, or pivoted, against the elongate body (110) of the glide bomb (100) and an extended position (see FIG. 4) in which the stabilisers (133) are operable.

When in the retracted position as shown, the outer end (136) of each stabiliser (133) is pivoted towards the nose (112) of the body (110) of the glide bomb (100).

Advantageously, when in the retracted position, any interference with a UAV carrying the glide bomb (100) is reduced.

Referring to FIG. 4, each horizontal stabiliser (133) is pivotally mountable to the body (110) at the tail (114) to be selectively pivotable between a retracted position (as shown in FIG. 3) and the extended position as shown.

In use, the glide bomb (100) is configured to pivot the horizontal stabilisers (133) to the extended position as soon as the glide bomb (100) is released from a UAV or operative to thereby provide at least partial flight control.

Like with the wings (120), pivoting of each horizontal stabiliser (133) relative to the body (110) of the glide bomb (100) is actuated by a servomotor.

Referring to both FIGS. 3 and 4, the glide bomb (100) like in the first embodiment is configured to be mounted to an underside of a UAV (not shown) by a release mechanism operatively associated with a firing mechanism of the UAV (not shown) for triggering deployment of the glide bomb (100) from the UAV (not shown) upon receiving a firing command.

The release mechanism includes two mounting forks configured to be at least partially received in mounting slots (310) defined on an upper surface of the body (110) of the glide bomb (100). The two mounting forks are configured to release the bomb (100) in a synchronous manner upon receiving the firing command.

Target information is transmitted via a severable wired serial link between the UAV (not shown) or operative (not shown) and the glide bomb (100) prior to the glide bomb being deployed. The wired serial link connects to inlet port (320) defined forward of the mounting slots (310) on the upper surface of the body (110) of the glide bomb (100). The link is configured to be severed when the glide bomb (100) is released.

As shown, the glide bomb (100) in this embodiment further includes a pitot probe (330) extending forward of the nose (112) of the body (110) for measuring fluid flow velocity and therefore airspeed.

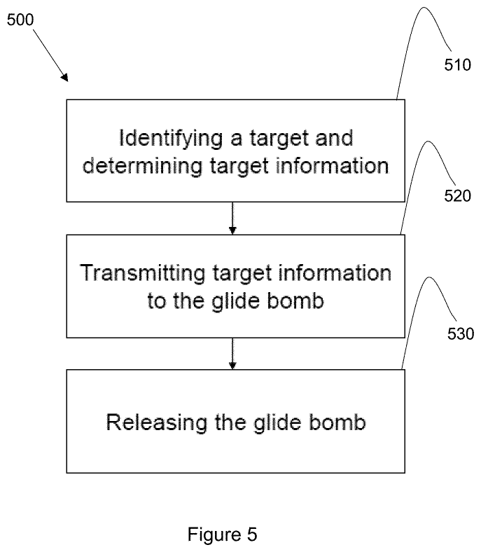

A method (500) of releasing the glide bomb (100) from the UAV (900) as shown in FIGS. 1 to 4 is now described in detail with reference to FIG. 5.

At step 510, the UAV (900) targeting system identifies a target and determines target information, including a distance to target, and a pitch angle, a yaw angle and an altitude required to strike the target with the glide bomb (100).

At step 520, the UAV (900) transmits the target information to the glide bomb (100) via a wired serial link.

At step 530, the glide bomb (100) is released from the UAV (900) upon receiving a firing command from the UAV (900) operator.

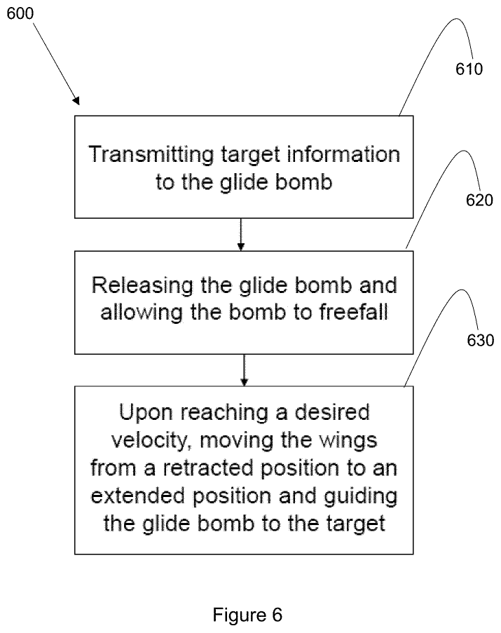

A flight trajectory method (600) the glide bomb (100) as shown in FIGS. 1 to 4 is now described in detail with reference to FIG. 6.

At step 610, the UAV (900) targeting system identifies a target and determines target information, including a distance to target, and a pitch angle, a yaw angle and an altitude required to strike the target with the glide bomb (100). The UAV (900) then transmits the target information to the glide bomb (100) via a wired serial link short range RF radio link (e.g., Bluetooth).

At step 620, the glide bomb (100) is released from the UAV (900) upon receiving a firing command from the UAV (900) operator. The glide bomb (100) freefalls with the wings (120) in the retracted position until a desired velocity is attained to maintain glided flight towards the target.

The velocity is determined via a determination of the dynamic pressure of the glide bomb (100).

At step 630, upon reaching the desired velocity, the wings (120) of the glide bomb (100) transition from the retracted position at least partially towards the extended position to provide lift, flight control and an optimum glide ratio of between about 15 and about 17.

The guidance system of the glide bomb (100) autonomously guides the glide bomb (100) to the target for target strike.

In some embodiments, the method (400) further includes transitioning the glide bomb (100) to a terminal strike mode as the glide bomb (100) nears the target. For example, upon reaching a predetermined proximity to the target, the wings (120) of the glide bomb (100) at least partially retract and the glide bomb (100) pitches downwards to accelerate for target strike.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A glide bomb configured to be carried and released by an unmanned or manned aerial vehicle for flight towards a selected target, said glide bomb comprising:
an elongate body having a nose and an opposed tail aligned along a longitudinal axis;
a payload;
a pair of wings extendable from opposed sides of the body for producing lift, said wings configured to be selectively moveable between a retracted position and an extended position; and
two or more tail control surfaces operatively associated with the tail of the body for at least pitch and yaw control.

2. The glide bomb of claim 1, wherein the glide bomb is configured to be carried and released by an unmanned aerial vehicle (“UAV”).

3. The glide bomb of claim 1, wherein the glide bomb has a flight range from deployment to target of between about 2,000 m and about 4,000 m.

4. The glide bomb of claim 1, wherein each of the pair of wings is pivotally mountable to the elongate body about an inner end so that the outer end is pivotable between the retracted position and the extended position.

5. The glide bomb of claim 1, wherein the wings are selectively pivotable between the retracted position and the extended position relative to the elongate body over a range of between about 70° to about 90°.

6. (canceled)

7. The glide bomb of claim 1, wherein each of said wings can be selectively moved to a swept back position for one or more of high-speed flight, roll control and longitudinal trim of the glide bomb in flight.

8. The glide bomb of claim 1, wherein the wings are configured to be selectively pivoted at least partially between the retracted position and the extended position to enable the glide bomb to transition between a stowage and freefall mode, a low-speed flight mode, a high-speed flight mode and/or for roll control as required.

9. The glide bomb of claim 1, wherein the two or more tail control surfaces comprise at least one vertical stabiliser having at least one rudder and a pair of opposed horizontal stabilisers each having at least one elevator for control yaw and pitch motion of the glide bomb, respectively.

10. The glide bomb of claim 9, wherein the pair of opposed horizontal stabilisers are moveable between a retracted position in which the stabilisers are folded against the elongate body and an extended position in which the horizontal stabilisers are operable.

11. (canceled)

12. The glide bomb of claim 10, wherein the pair of horizontal stabilisers are selectively pivotable between the retracted position, the extended position and one or more positions therebetween.

13. (canceled)

14. The glide bomb of claim 2, wherein the glide bomb is mounted to an underside of the UAV by a release mechanism operatively associated with a firing mechanism for triggering deployment of the glide bomb from the UAV upon receiving a firing command.

15. The glide bomb of claim 1, further comprising at least one image capturing device for facilitating flight control of the glide bomb.

16. The glide bomb of claim 1, further comprising a range finder of determining a distance between the glide bomb and the selected target.

17. The glide bomb of claim 1, further comprising at least one guidance system for guiding flight of the guide bomb to the target when released and after having received target coordinates prior to release.

18. The glide bomb of claim 17, wherein the at least one guidance system comprises an inertial navigation system and a global navigational satellite system (“GNSS”).

19. The glide bomb of claim 18, wherein the at least one guidance system is configured to switch from the GNSS to the inertial navigation system as the glide bomb nears the target.

20. The glide bomb of claim 1, further comprising at least one controller for controlling flight of the glide bomb to target the target.

21. The glide bomb of claim 20, wherein the at least one controller is in communication with an external controller over a communications network for at least part of a flight of the glide bomb.

22. The glide bomb of claim 20, wherein the at least one controller is in communication with a like at least one controller of other like glide bombs deployed to coordinate at least one of a strike, a synchronous or near synchronous strike and collision avoidance.

23. (canceled)

24. A method of deploying a glide bomb from an unmanned or manned aerial vehicle, said method comprising:
providing an aerial vehicle, said aerial vehicle carrying at least one glide bomb, comprising:
an elongate body having a nose and an opposed tail aligned along a longitudinal axis;
a payload;
a pair of wings extendable from opposed sides of the body for producing lift, said wings configured to be selectively moveable between a retracted position and an extended position; and
two or more tail control surfaces operatively associated with the tail of the body for at least pitch and yaw control;
identifying a target and determining target information including a distance to target, a pitch angle, a yaw angle and an altitude required to strike the target with the at least one glide bomb;
transmitting the target information to the at least one glide bomb; and
releasing the at least one glide bomb.

25-29. (canceled)
